(19) United States
(12) Patent Application Publication
(10) Pub. No.: US 2026/0095497 A1
(43) Pub. Date: Apr. 2, 2026

(54) Conferencing Quality-of-Service Concierge

(71) Applicant: RingCentral, Inc., Belmont, CA (US)

(72) Inventor: Martin Arastafar, Redwood Shores, CA (US)

(73) Assignee: RingCentral, Inc., Belmont, CA (US)

(21) Appl. No.: 18/901,320

(22) Filed: Sep. 30, 2024

(51) Int. Cl. H04L 65/80; H04L 65/403

(52) U.S. Cl. CPC H04L 65/80; H04L 65/403

(57) ABSTRACT

The present disclosure provides methods, systems, and mediums for diagnosing quality-of-service problems. The method comprises the steps of during an online conferencing session with multiple participants, receiving, by a conference management system, a first stream from a first computing device of multiple computing devices connected to the online conferencing session. The method further comprises receiving, by the conference management system, a second stream of a content from a second computing device of the multiple computing devices. The method further comprises identifying a trigger event from the content of the second stream. The method further comprises diagnosing, by the conference management system, whether there is a problem associated with the first stream based on the trigger event.

### TECHNICAL FIELD

The present disclosure relates generally to the field of computer-supported meetings or conferences. More specifically, and without limitation, this disclosure relates to systems and methods for automatically diagnosing and remediating quality-of-service (“QoS”) problems associated with quality of audio and/or video data during computer-supported meetings or conferences.

### BACKGROUND

Computer-supported conferencing has become an essential tool for conducting meetings with participants in different physical locations. Advances in video conferencing software have enabled software to dynamically switch audio and/or video streams between different participants based on which speaker is actively speaking. For example, when a first participant in one location begins speaking, the video conferencing software may be implemented to automatically show video for the first participant when they begin to speak. Additionally, if a second participant, in another location, begins to speak the video conferencing software may automatically switch to show video of the second participant speaking. This feature of automatically switching a video feed to the active speaker allows other participants to stay engaged and follow the conversation both auditorily and visually.

However, to have a smooth conference presentation experience, the audio and/or video streams of different participants need to be free of any technical performance issues that may cause a delay or interruption in the audio and/or video stream. For example, if the first participant is called upon to make an audio and video presentation but their computing device is experiencing network interruptions, then presentation to the other participants may be delayed or interrupted entirely until the first participant resolves their technical performance issues.

Examples of issues that may affect the overall quality-of-service may include network transmission issues, physical computing device issues such as a failing microphone or camera, or computing device configuration issues such as the presenter accidentally muting himself.

In situations where a presenting participant has accidentally muted themselves, the other participants may alert the presenting participant by interrupting them auditorily, raising a virtual hand, or making physical gestures to get the presenting participant's attention. However, each of these options to get the presenting participant's attention is reliant on the presenting participant observing the gestures from other participants in order to be alerted of the problem. Thus, systems and methods are desired for more accurately diagnosing and remediating quality-of-service problems associated with quality of audio and/or video data transmitted by one or more meeting participants.

### SUMMARY

The appended claims may serve as a summary of the invention.

### BRIEF DESCRIPTION OF THE DRAWINGS

The accompanying drawings, which comprise a part of this specification, illustrate several embodiments and, together with the description, serve to explain the principles disclosed herein. In the drawings:

FIG. 1 depicts a diagram of a communication system suitable for realization of one of the embodiments of a conferencing platform, according to the present disclosure.

FIG. 2 depicts an illustration of the conference management server, according to an embodiment.

FIG. 3 is a diagram of a computing device for use in a communication system, according to an embodiment.

FIG. 4 depicts a flowchart for diagnosing whether there is a quality-of-service problem associated with a conferencing session based on an identified triggering event, according to an embodiment.

FIG. 5 depicts a flowchart for remediating an identified quality-of-service problem associated with a conferencing session based on an identified triggering event, according to an embodiment.

FIG. 6 depicts an example machine learning architecture, according to an embodiment.

### DETAILED DESCRIPTION

Before various example embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein.

It should also be understood that the terminology used herein is for the purpose of describing concepts, and the terminology is not intended to be limiting. Unless defined otherwise, all technical and scientific terms used herein have the same meaning as commonly understood by those skilled in the art to which the embodiment pertains.

Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that the singular forms of “a,” “an,” and “the” include plural references unless the context clearly dictates otherwise.

Some portions of the detailed descriptions that follow are presented in terms of procedures, methods, flows, logic blocks, processing, and other symbolic representations of operations performed on a computing device or a server. These descriptions are the means used by those skilled in the arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical, optical, or magnetic signals capable of being stored, transferred, combined, compared, and otherwise manipulated in a computer system or computing device or a processor. These signals are sometimes referred to as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “storing,” “determining,” “sending,” “receiving,” “generating,” “creating,” “fetching,” “transmitting,” “facilitating,” “providing,” “forming,” “detecting,” “processing,” “updating,” “instantiating,” “identifying”, “contacting”, “gathering”, “accessing”, “utilizing”, “resolving”, “applying”, “displaying”, “requesting”, “monitoring”, “changing”, “updating”, “establishing”, “initiating”, or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

A “computer” is one or more physical computers, virtual computers, and/or computing devices. As an example, a computer can be one or more server computers, cloud-based computers, cloud-based cluster of computers, virtual machine instances or virtual machine computing elements such as virtual processors, storage and memory, data centers, storage devices, desktop computers, laptop computers, mobile devices, Internet of Things (IOT) devices such as home appliances, physical devices, vehicles, and industrial equipment, computer network devices such as gateways, modems, routers, access points, switches, hubs, firewalls, and/or any other special-purpose computing devices. Any reference to “a computer” herein means one or more computers, unless expressly stated otherwise.

The “instructions” are executable instructions and comprise one or more executable files or programs that have been compiled or otherwise built based upon source code prepared in JAVA, C++, OBJECTIVE-C, or any other suitable programming environment.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

Computer storage media can include volatile and nonvolatile, removable, and non-removable media implemented in any method or technology for storage of information such as computer-readable instructions, data structures, program modules, or other data. Computer storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, solid state drives, hard drives, hybrid drive, or any other medium that can be used to store the desired information and that can be accessed to retrieve that information.

It is appreciated that present systems and methods can be implemented in a variety of architectures and configurations. For example, present systems and methods can be implemented as part of a distributed computing environment, a cloud computing environment, a client server environment, hard drive, etc. Example embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular data types. The functionality of the program modules may be combined or distributed as desired in various embodiments.

It should be understood that terms “user” and “participant” have equal meaning in the following description.

### General Overview

The current disclosure provides a technical solution to the technological problem of diagnosing and remediating quality-of-service problems associated with the quality of audio and/or video data transmitted by one or more meeting participants. Generally, a conferencing system hosts online conferencing sessions that may include multiple participants that may be providing their audio and/or video streams to a conference management server for distribution to connected computing devices. In some cases, where there are observed audio and/or video quality-of-service problems during an online conferencing session, it is desirable to automatically detect the quality-of-service problems and remediate the quality-of-service problems without any major disruptions to the ongoing online conferencing session.

The current disclosure solves the problem of diagnosing quality-of-service problems by identifying a trigger event from content of a stream and diagnosing whether the trigger event is indicative of a quality-of-service problem. In one aspect of the present disclosure, a computer-implemented method for diagnosing quality-of-service problems is disclosed. The computer-implemented method comprises the steps of during an online conferencing session with multiple participants, receiving, by a conference management system, a first stream from a first computing device of multiple computing devices connected to the online conferencing session, and receiving, by the conference management system, a second stream of a content from a second computing device of the multiple computing devices. The method further comprises identifying a trigger event from the content of the second stream and diagnosing, by the conference management system, whether there is a problem associated with the first stream based on the trigger event.

In another example embodiment, the method further comprises sending an alert notification to the first computing device to alert the first participant of the problem. In another example embodiment, the method further comprises prior to sending the alert notification to the first computing device, including a diagnosis of the problem into the alert notification.

In another embodiment of the present disclosure, wherein diagnosing whether there is the problem associated with the first stream based on the trigger event, comprises: determining whether the trigger event is indicative of the problem, wherein the problem is a quality-of-service problem, and upon determining that the trigger event is indicative of the problem, identifying one or more potential sources of the problem.

In another embodiment of the present disclosure, wherein the second stream is a video stream, and the trigger event represents one or more gestures indicating an issue hearing or viewing the first stream.

In another embodiment of the present disclosure, wherein the second stream is an audio stream, and the trigger event represents speech from the audio stream indicating an issue hearing or viewing the first stream.

In another example embodiment, the method further comprises receiving, by the conference management system, a third stream from a third computing device of the multiple computing devices, and wherein the third stream contains content affirming the problem diagnosed from the trigger event and the first stream.

In an embodiment, the method further comprises remediating, by the conference management system, the problem. In another embodiment of the present disclosure, wherein remediating the problem further comprises using a machine learning model to determine one or more remediation plans to fix the problem using the second stream and the trigger event as input to the machine learning model, and providing as output, from the machine learning model, the one or more remediation plans to resolve the problem. In yet another embodiment of the present disclosure, wherein remediating the problem further comprises determining one or more remediation plans for remediating the problem associated with the first stream, retrieving the one or more remediation plans from a historical repository of remediation plans directed to solve multiple different problems associated with the online conferencing session, executing at least one of the one or more remediation plans to fix the problem, sending a notification to at least one computing device of the multiple computing devices connected to the online conferencing session indicating that the problem associated with the first stream has been remediated.

According to a second aspect of the present disclosure, a system for diagnosing quality-of-service problems is proposed. The system comprises a processor; and a memory storing instructions that, when executed by the processor, causes: during an online conferencing session with multiple participants, receiving, by a conference management system, a first stream from a first computing device of multiple computing devices connected to the online conferencing session; receiving, by the conference management system, a second stream of a content from a second computing device of the multiple computing devices; identifying a trigger event from the content of the second stream; and diagnosing, by the conference management system, whether there is a problem associated with the first stream based on the trigger event.

According to a third aspect of the present disclosure, a non-transitory, computer-readable medium for diagnosing quality-of-service problems is proposed. The medium stores a set of instructions that, when executed by a processor, cause the following: during an online conferencing session with multiple participants, receiving, by a conference management system, a first stream from a first computing device of multiple computing devices connected to the online conferencing session; receiving, by the conference management system, a second stream of a content from a second computing device of the multiple computing devices; identifying a trigger event from the content of the second stream; and diagnosing, by the conference management system, whether there is a problem associated with the first stream based on the trigger event. Thus, the current solution provides a technological benefit of automatically diagnosing quality-of-service problems during an online conferencing session and remediating the quality-of-service problems.

### Structural Overview

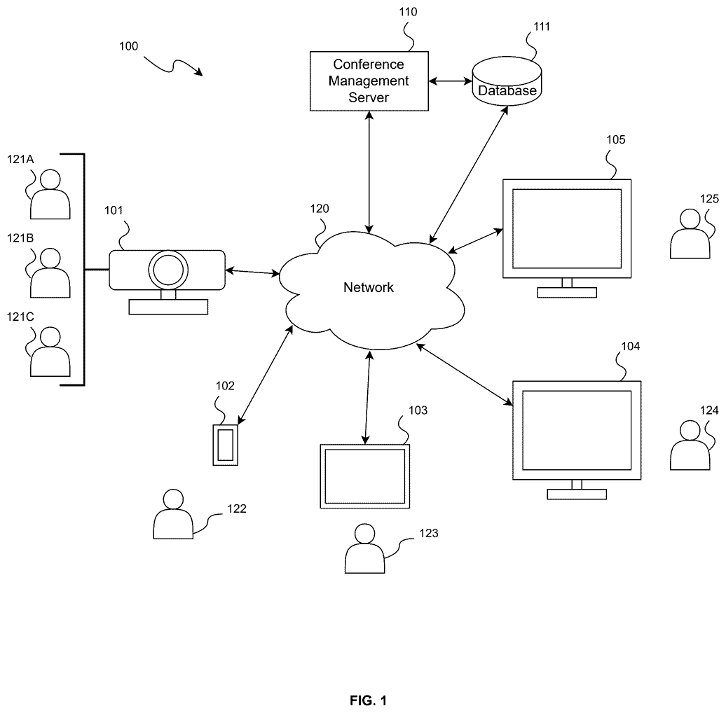

FIG. 1 depicts a diagram of a communication system suitable for realization of one of the embodiments of a conferencing platform, according to the present disclosure. The communication system 100 facilitates communications between computing devices 101 associated with users 121A, 121B, 121C, and computing devices 102, 103, 104, and 105, each associated with corresponding users 122, 123, 124 and 125, respectively. FIG. 1 further shows a conference management server 110, and a database 111. Network 120 may be any type of network that provides communications or facilitates the exchange of information between the conference management server 110 and computing devices 101, 102, 103, 104, and 105. For example, network 120 broadly represents one or more local area networks (LANs), wide area networks (WANs), metropolitan area networks (MANs), global interconnected internetworks, such as the public internet, or other suitable connection(s) or combination thereof that enables communication system 100 to send and receive information between the computing devices 101, 102, 103, 104, and 105 and the conference management server 110. Each such network 120 uses or executes stored programs that implement internetworking protocols according to standards such as the Open Systems Interconnect (OSI) multi-layer networking model, including but not limited to Transmission Control Protocol (TCP) or User Datagram Protocol (UDP), Internet Protocol (IP), Hypertext Transfer Protocol (HTTP), and so forth. All computers described herein are configured to connect to the network 120 and the disclosure presumes that all elements of FIG. 1 are communicatively coupled via network 120. A network may support a variety of electronic messaging formats and may further support a variety of services and applications for computing devices 101, 102, 103, 104, and 105.

Computing devices may include, but are not limited to, a desktop computing device 101, 104 and 105 executing any known operational environment, e.g., Windows®, MacOS®, Linux® or Unix®. At the same time, other computing devices may be mobile telephones, such as smartphone devices, e.g., computing device 102, or tablets, e.g., computing device 103, executing any of the known operational environments, e.g., Android® or iOS.

In accordance with the present disclosure, computing devices 101, 102, 103, 104 and 105 are programmed to send and receive audio and video streams to and from the conference management server 110 via network 120.

### Functional Overview

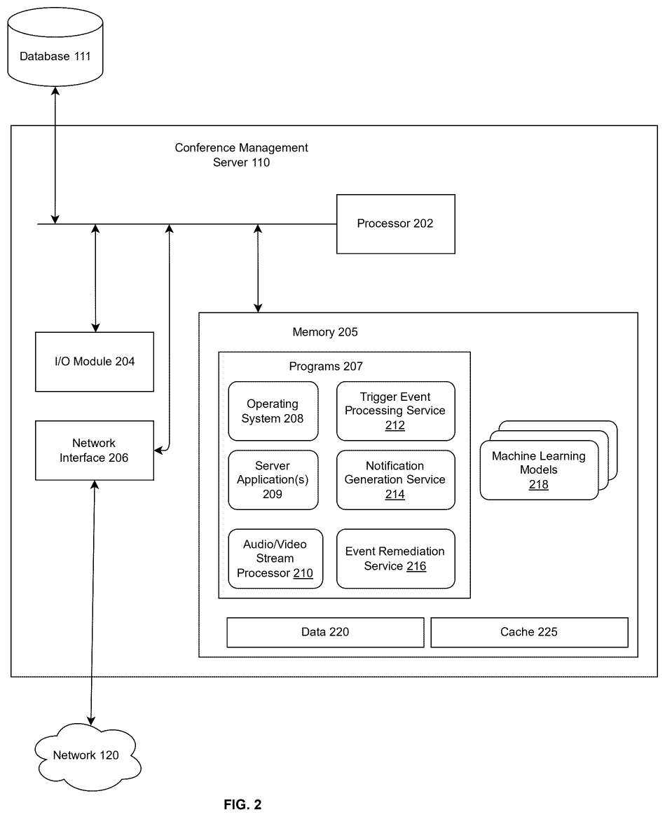

Reference is now made to FIG. 2, which depicts an illustration of the conference management server 110, according to an example embodiment. The conference management server 110 may include at least one processor, e.g., processor 202. The processor 202 may be operably connected to one or more databases (e.g., database 111), an input/output (I/O) module 204, memory 205, and network interface device 206.

I/O module 204 may be operably connected to a keyboard, mouse, touch screen controller, and/or other input controller(s) (not shown). Other input/control devices connected to I/O module 204 may include one or more touchpads, trackballs, buttons, rocker switches, thumbwheel, infrared port, USB port, and/or a pointer device such as a stylus.

Processor 202 may also be operably connected to memory 205. Memory 205 may include high-speed random-access memory and/or non-volatile memory, such as one or more magnetic disk storage devices, one or more optical storage devices, and/or flash memory (e.g., using NAND, NOR gates).

Memory 205 may include one or more programs 207. For example, memory 205 may store an operating system 208, such as DARWIN, RTXC, Linux®, iOS, Unix®, OS X, Windows®, or an embedded operating system such as VXWorks®. Operating system 208 may include instructions for handling basic system services and for performing hardware dependent tasks. In some implementations, operating system 208 may comprise a kernel (e.g., UNIX kernel). In an embodiment, programs 207 may also include server applications 209, an audio and video stream processor 210, a trigger event processing service 212, and event remediation service 216, and a notification generation service 216. In yet other embodiments, programs 207 may include more or fewer services than what is depicted in FIG. 2. In an example embodiment, server applications 209 may represent one or more applications configured to facilitate communicating with one or more additional devices, one or more computers and/or one or more servers.

Memory 205 may also include cache 225. Cache 225 may represent a dedicated area, within memory 205, configured to store conference-related data and participant-specific behavior data related to participant-specific interactions and gestures that may indicate a potential quality-of-service problem with one or more data streams. Examples of participant-specific interactions and gestures may include, but are not limited to, how a participant interrupts a conversation, how a participant conveys an affirmation, how a participant conveys dissatisfaction, and any other physical or emotional response that may convey a point. The conference-related data may include audio streams and video streams from participants, voiceprint data associated with each of the participants, and any other data related to participants, participant computing devices, and their corresponding conferences. Memory 205 may also store data 220. Data 220 may include transitory data used during instruction execution. Data 220 may also include data recorded for long-term storage.

In an embodiment, the audio and video stream processor 210 is configured to receive audio and video data, in the form of audio streams and video streams, from one of more computing devices 101-105 and write the audio/video data into cache 225. The video stream may represent video captured using a video capture device communicatively coupled to computing device 101. The video capture device may include, but is not limited to, a camera device integrated into computing device 101 and an external camera device communicatively coupled to computing device 101, such as an external wired camera as well as an external wireless camera. The audio stream may represent audio captured using an audio capture device, such as a microphone, communicatively coupled to computing device 101. In an embodiment, the audio and video stream processor 210 may implement one or more computer processes to write the audio data to the cache 225 as audio is being captured in real-time.

In an embodiment, the trigger event processing service 212 is configured to identify a trigger event from received audio and/or video streams from one or more computing devices 101-105. A trigger event may be any type of audio clip, video clip, or other online interaction that contains an action or event that indicates a problem associated with either the transmitted audio, the transmitted video, or both. Examples of a trigger event may include, but are not limited to, physical gestures, audible sounds, words, or phrases spoken by one or more meeting participants, and received chat messages.

The trigger event processing service 212 identifies trigger events by monitoring the received audio and video streams from computing devices 101-105 for any trigger events. For example, the trigger event processing service 212 monitors received audio streams for any words or phrases that may indicate a potential problem with the presented stream from the conference management server 110. Examples of words or phrases may include, but are not limited to, “wait!”, “there's a problem”, “hello, we can't hear you”, “no sound”, “no video”, “anyone else having an issue?”, or any other word or phrase that is indicative of a quality-of-service problem with the ongoing conference. Examples of video-based gestures may include, but are not limited to, waving hands, raising a hand, a particular gesture such as waving one's arms, cupping of one's ear to indicate no sound, a praying hands gesture to indicate one's desperate desire that video quality will be restored, or any other gesture to indicate an issue with either the audio or video. In another example embodiment, the trigger event processing service 212 may be configured to monitor chat messages exchanged within the online conferencing session for trigger events. For example, if a participant writes “we can't hear you Nancy” in the chat window, the trigger event processing service 212 may parse the chat messages and identify the phrase “we can't hear you Nancy” as a trigger event indicating a potential problem with either the audio stream associated with participant named Nancy.

In an embodiment, the trigger event processing service 212 may implement a trained machine learning model 218 for identifying trigger events from audio and video streams from computing devices 101-105. Referring to FIG. 2, machine learning model 218 may represent one or more trained machine learning models implemented to identify trigger events from streams, analyze whether trigger events are indicative of a quality-of-service problems, and locate a source of a potential quality-of-service problem. For example, the trigger event processing service 212 may implement a trained machine learning model 218 that receives, as input, audio and video streams from meeting participants. The trained machine learning model 218 analyzes the audio and video streams and provides, as output, one or more trigger events identified from the audio and video streams. The trained machine learning model 218 may be implemented using one or more of: Artificial Neural Networks (ANN), Deep Neural Networks (DNN), XLNet for Natural Language Processing (NLP), General Language Understanding Evaluation (GLUE), Word2Vec, Convolution Neural Networks (CNN), Long Short-Term Memory (LSTM) networks, Gated Recurrent Unit (GRU) networks, Hierarchical Attention Networks (HAN), or any other type of machine learning model. The machine learning models listed herein serve as examples and are not intended to be limiting. In other examples, the trigger event processing service 212 may implement any other algorithm configured to identify trigger events from an audio and video streams. A detailed example of implementing a neural network is described in the MACHINE LEARNING MODEL section herein.

Upon identifying a trigger event, the trigger event processing service 212 may determine whether the trigger event is indicative of a quality-of-service problem related to either an audio stream, video stream, or both. In an embodiment, the trigger event processing service 212 may be implemented to use historical meeting data to help determine whether a trigger event is indicative of a quality-of-service problem. Examples of historical meeting data may include, but is not limited to, historical meeting interaction data from past meetings, interaction data from past meetings involving the same participants as the current meeting, as well as historically identified trigger events that were quality-of-service problems from specific participants in the current meeting. Historical interaction data of specific participants from past meetings are particularly insightful for predicting whether a current trigger event is indicative of a quality-of-service problem. For example, if, a particular participant frequently asks other participants to pause or wait during meetings, then the trigger event processing service 212 may determine that the audible “wait!” trigger event is not indicative of a quality-of-service problem but rather indicative of the particular participant needing extra time during the meeting. In an embodiment, the trigger event processing service 212 may be configured to access audio and video streams from other participants to verify whether there may be a quality-of-service problem with one or more streams. For instance, the trigger event processing service 212, when determining whether there is an audio quality-of-service problem, may analyze the audio streams from the other participants to determine whether multiple participants experienced a quality-of-service problem. If multiple audio streams exhibited interruptions that would indicate a quality-of-service problem, then the trigger event processing service 212 may determine that the audible “wait!” trigger event is indicative of a quality-of-service problem.

In an embodiment, the trigger event processing service 212 may implement a trained machine learning model 218 configured to determine whether an identified trigger event describes a quality-of-service problem occurring within the online meeting. For example, the trigger event processing service 212 may implement a trained machine learning model 218 that receives, as input, a trigger event. Output of the trained machine learning model 218 may be output indicating whether the trigger event describes an existing quality-of-service problem with the online meeting. For example, the output may include the trigger event, whether a quality-of-service problem exists, and the type of quality-of-service problem. For instance, the output may indicate whether the quality-of-service problem is audio related, video related, chat message related, or some combination of streams. The trained machine learning model may be implemented using one or more of: Artificial Neural Networks (ANN), Deep Neural Networks (DNN), XLNet for Natural Language Processing (NLP), General Language Understanding Evaluation (GLUE), Word2Vec, Convolution Neural Networks (CNN), Long Short-Term Memory (LSTM) networks, Gated Recurrent Unit (GRU) networks, Hierarchical Attention Networks (HAN), or any other type of machine learning model. The machine learning models listed herein serve as examples and are not intended to be limiting.

Upon determining that the trigger event is related to a quality-of-service problem, the trigger event processing service 212 may attempt to locate the source of problem. For instance, if the trigger event processing service 212 identifies the particular trigger event as indicating a potential audio stream problem, the trigger event processing service 212 may attempt to diagnose the source of the audio problem, such as determining whether there is an ongoing audio stream problem with one of the audio streams published by one of the computing devices 101-105 or whether the audio stream problem is localized to the computing device that indicated there is a problem. For example, referring to FIG. 1, user 121A may be presenting using computing device 101, and the audio and video streams from computing device 101 are being provided to the conference management server 110, which is then sending the audio and video streams to computing devices 102-105 for presentation. If user 122 audibly says into computing device 102 “I can't hear anything”, the trigger event processing service 212 may detect, from the audio stream from computing device 102, a particular trigger event. The trigger event processing service 212 may determine the type of problem associated with the particular trigger event based on the trigger event content. For instance, the particular trigger event “I can't hear anything”, may be interpreted as an audio-related issue based on the words “can't hear” from the trigger event.

Upon determining the type of quality-of-service problem associated with the trigger event, the trigger event processing service 212 may determine a source of the quality-of-service problem. Using the previous example, where the trigger event of “I can't hear anything” has been identified as being associated with an audio quality-of-service problem, the trigger event processing service 212 may determine the source of the audio issue by determining whether the audio issue originates at the computing device generating the audio stream or whether the audio issue originates at the computing device that caused the trigger event. The trigger event processing service 212 may evaluate the audio stream generated by the presenting computing device, computing device 101, as well as processes running on computing device 102, which is the computing device that received the audio stream from computing device 101 and generated the trigger event. When evaluating the audio stream generated by computing device 101, if the trigger event processing service 212 detects missing audio packets from the audio stream or delays in sending audio packets, then the trigger event processing service 212 may determine that the source of the audio problem is the presenting computing device, namely computing device 101. Additionally, the trigger event processing service 212 may evaluate the trigger event reporting computing device, computing device 102, for any issues receiving the audio stream from computing device 101. If the trigger event processing service 212 find errors in receiving audio on computing device 102, then the trigger event processing service 212 may conclude that the receiving computing device, computing device 102, is the source of the problem.

In an example embodiment, the trigger event processing service 212 may implement a trained machine learning model 218 configured to determine the source of the quality-of-service problem associated with an identified trigger event. For example, the trigger event processing service 212 may implement a trained machine learning model 218 that receives, as input: the trigger event, the type of quality-of-service problem associated with the trigger event, multiple streams from computing devices participating in the meeting including streams from the specific computing device that reported the trigger event. The trained machine learning model 218 may then output a prediction of the source of the quality-of-service problem. For instance, if the quality-of-service problem is a transmission issue originating from the presenting computing device, computing device 101, then the output from the trained machine learning model 218 may identify computing device 101 as the source of the audio quality-of-service problem. The trained machine learning model may be implemented using one or more of: Artificial Neural Networks (ANN), Deep Neural Networks (DNN), XLNet for Natural Language Processing (NLP), General Language Understanding Evaluation (GLUE), Word2Vec, Convolution Neural Networks (CNN), Long Short-Term Memory (LSTM) networks, Gated Recurrent Unit (GRU) networks, Hierarchical Attention Networks (HAN), or any other type of machine learning model. The machine learning models listed herein serve as examples and are not intended to be limiting.

The trigger event processing service 212 may determine the source of the quality-of-service problem by gathering additional information from other participants. In an embodiment, the feedback from other participants may be used to pinpoint or narrow the possible source of the quality-of-service problem. For example, the trigger event processing service 212 may send notification messages to one or more participants of an online meeting to determine the scope of the quality-of-service problem. Specifically, the trigger event processing service 212 may make a request to the notification generation service 214 to generate notification messages for the one or more participants of the online meeting. The notification messages may include an inquiry about the quality-of-service experienced by each participant. For example, if the trigger event identified indicates that a participant is experiencing a loss of audio. The trigger event processing service 212 may determine the source of the lost audio issue by requesting that the notification generation service 214 send out notification messages to each of the participants. Each notification message may contain a prompt asking the participant whether they are experiencing any audio quality issues. Based on the feedback, the trigger event processing service 212 may determine the source of the quality-of-service problem. For instance, if the feedback indicates that the only computing device experiencing audio issues is the computing device that caused the trigger event, which is computing device 102, then the trigger event processing service 212 may conclude that the audio issue is local to the reporting computing device, computing device 102. If, however, the feedback indicates that multiple computing devices are experiencing the audio issues, then the trigger event processing service 212 may conclude that the audio issue may be caused by the presenter's computing device, computing device 101.

In an embodiment, the notification generation service 214 is implemented to generate and send notification messages to one or more participants during an online meeting session. The notification generation service 214 may generate various types of notification messages, including, but not limited to, popup notifications, banner notifications, or any other type of push notification implemented to inform the participant using the computing device that there may be a quality-of-service problem. The notification generation service 214 may generate notifications to inquire whether multiple participants are experiencing quality-of-service problems. For example, the notification generation service 214 may generate and send notification messages to participants, where the notification messages contain content asking each participant whether they are currently experiencing quality-of-service problems with either audio, video, or both streams. In another example, if the trigger event processing service 212 has determined that a presenting participant has accidentally muted their computing device, the notification generation service 214 may generate and send a notification to the presenting participant that informs the presenting participant that they are muted, and they should unmute themselves before continuing with their presentation. Additionally, the notification generation service 214 may be used to notify participants of an ongoing quality-of-service problem. For example, if trigger event processing service 212 determines that there is an ongoing audio issue affecting multiple participants, the notification generation service 214 may send notifications to the multiple participants informing the participants that there is an ongoing audio issue, and that the system is working to remediate the issue.

In an embodiment, the event remediation service 216 is implemented remediate quality-of-service problems occurring during the online meeting session. The event remediation service 216 may be configured to maintain a repository of remediation plans for different types of quality-of-service problems. The repository of remediation plans may be stored in database 111. When the trigger event processing service 212 determines a potential source of the quality-of-service problem, the trigger event processing service 212 may send a request to the event remediation service 216 to remediate the quality-of-service problem based on the identified potential source. If the quality-of-service problem identified a specific presenting computing device, such as computing device 101, as experiencing audio issues while presenting, the event remediation service 216 may access one or more remediation plans from the repository of remediation plans that are directed to remediating the specific quality-of-service problem on computing device 101. For example, the trigger event processing service 212 may send instructions to the event remediation service 216 indicating that computing device 101 is not receiving any Real-time Transport Protocol (RTP) packets. The event remediation service 216 may access one or more remediation plans from the repository directed to fixing RTP interruptions. The one or more remediation plans may contain instructions to change the port used by computing device 101. In other examples, remediation plans stored in database 111 may contain plans to fix issues related to, noise cancellation, background noise, video quality, video frame rate, microphone issues, and any other type of quality-of service issue related to an online conferencing session. In other examples where the event remediation service 216 is unable to resolve the quality-of-service defect or failure, the event remediation service 216 may escalate the issue by sending an alert notification to an IT ticketing service or to a human operator to remediate the quality-of-service problem.

In an embodiment, the event remediation service 216 may implement a trained machine learning model 218 configured to select an appropriate remediation plan for a quality-of-service problem and execute instructions detailed in the appropriate remediation plan. For example, the event remediation service 216 may implement a trained machine learning model that receives, as input, the trigger event, the potential source of the quality-of-service problem associated with the trigger event, and any other stream or conference information about the current meeting session. Output of the trained machine learning model 218 may be a selected remediation plan with a set of instructions to be executed to fix the underlying quality-of-service problem. The trained machine learning model may be implemented using one or more of an ANN, DNN, NLP, GLUE, Word2Vec, CNN, LSTM networks, GRU networks, HAN, or any other type of machine learning model. The machine learning models listed herein serve as examples and are not intended to be limiting.

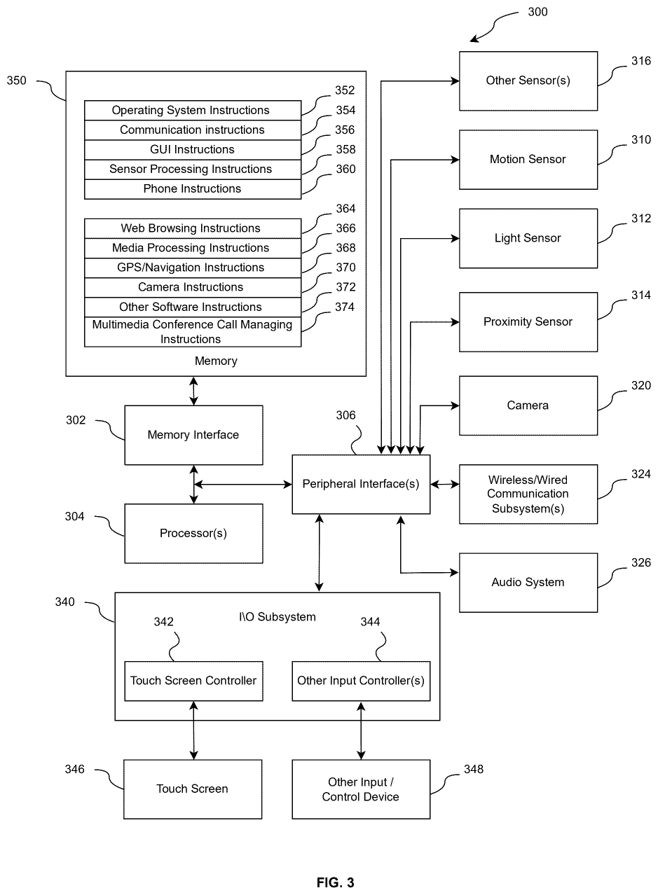

FIG. 3 is a diagram of a computing device 300 for use in a communication system, such as communication system 100. The computing device 300 can be used to implement computer programs, applications, methods, processes, or other software to perform embodiments described in the present disclosure, such as the computing devices 101-105. The computing device 300 includes a memory interface 302, a peripheral interface 306, one or more processors 304 such as data processors, image processors and/or central processing units. a peripheral interface 306.

The memory interface 302, the one or more processors 304, and/or the peripheral interface 306 can be separate components or can be integrated in one or more integrated circuits. The various components in the computing device 300 can be coupled by one or more communication buses or signal lines.

Sensors, devices, and subsystems can be coupled to the peripherals interface 306 to facilitate multiple functionalities. For example, a motion sensor 310, a light sensor 312, and a proximity sensor 314 can be coupled to the peripherals interface 306 to facilitate orientation, lighting, and proximity functions. Other sensors 316 can also be connected to the peripherals interface 306, such as a positioning system (e.g., GPS receiver), a temperature sensor, a biometric sensor, or other sensing device, to facilitate related functionalities. A GPS receiver can be integrated with, or connected to, the computing device 300. For example, a GPS receiver can be built into mobile telephones, such as smartphone devices, e.g., computing device 104, or into laptop, e.g., computing device 106. GPS software allows mobile telephones to use an internal or external GPS receiver (e.g., connecting via a serial port or Bluetooth®). A camera 320 and an optical sensor 322, e.g., a charged coupled device (“CCD”) or a complementary metal-oxide semiconductor (“CMOS”) optical sensor, may be utilized to facilitate camera functions, such as recording photographs and video clips.

Communication functions may be facilitated through one or more wireless/wired communication subsystems 324, which includes an Ethernet port, radio frequency receivers and transmitters and/or optical (e.g., infrared) receivers and transmitters. The specific design and implementation of the wireless/wired communication subsystem 324 depends on the communication network(s) over which the computing device 300 is intended to operate. For example, in some embodiments, the computing device 300 includes wireless/wired communication subsystems 324 designed to operate over a GSM network, a GPRS network, an EDGE network, a Wi-Fi® or WiMax® network, and a Bluetooth® network.

An audio system 326 may be used to facilitate voice-enabled functions, such as voice recognition, voice replication, digital recording, and telephony functions.

The I/O subsystem 340 includes a touch screen controller 342 and/or other input controller(s) 344. The touch screen controller 342 is coupled to a touch screen 346. The touch screen 346 and touch screen controller 342 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 346. While a touch screen 346 is shown in FIG. 3, the I/O subsystem 340 may include a display screen (e.g., CRT or LCD) in place of the touch screen 346.

The other input controller(s) 344 is coupled to other input/control devices 348, such as one or more buttons, rocker switches, thumbwheel, infrared port, USB port, and/or a pointer device such as a stylus. The touch screen 346 can, for example, also be used to implement virtual or soft buttons and/or a keyboard.

The memory interface 302 is coupled to memory 350. The memory 350 includes high-speed random-access memory and/or non-volatile memory, such as one or more magnetic disk storage devices, one or more optical storage devices, and/or flash memory (e.g., NAND, NOR). The memory 350 stores an operating system 352, such as DARWIN, RTXC, Linux®, iOS, Unix®, OS X, Windows®, or an embedded operating system such as VXWorks®. The operating system 352 can include instructions for handling basic system services and for performing hardware dependent tasks. In some implementations, the operating system 352 can be a kernel (e.g., UNIX kernel).

The memory 350 may also store communication instructions 354 to facilitate communicating with one or more additional devices, one or more computers and/or one or more servers. The memory 350 can include graphical user interface instructions to facilitate graphic user interface processing; sensor processing instructions to facilitate sensor-related processing and functions; phone instructions to facilitate phone-related processes and functions; electronic messaging instructions to facilitate electronic-messaging related processes and functions; web browsing instructions to facilitate web browsing-related processes and functions; media processing instructions to facilitate media processing-related processes and functions; GPS/navigation instructions to facilitate GPS and navigation-related processes and instructions; camera instructions to facilitate camera-related processes and functions; and/or other software instructions to facilitate other processes and functions. The memory 350 may also include multimedia conference call managing instructions to facilitate conference call related processes and instructions.

In some embodiments, the communication instructions 354 represent or include software applications to facilitate connection with the conference management server 110 of FIG. 1 that connects a plurality of computing devices. The graphical user interface instructions 356 may include a software program that facilitates display of the communication notifications to a user associated with the computing device and facilitates the user to provide user input, and so on.

In an embodiment, camera instructions 370 represent or include software applications to adjust the position of the camera 320. For example, computing device 300 may receive, from the instruction generation service 214, instructions to move the positioning of camera 320 such that the active speaker is either in focus or in the center of the captured video.

In the presently described embodiment, the instructions cause the processor 304 to perform one or more functions of the disclosed methods. For example, the instructions may cause the displaying of notifications, the sending of information to the conference management server 110 or the receiving of information from the conference management server 110.

In the presently described embodiment, memory 350 may contain specific instructions to perform functionalities of services disclosed in programs 207 of FIG. 2. For example, memory 350 may contain specific instructions to perform the functions of the trigger event processing service 212, notification generation service 214, and event remediation service 216. These specific instructions may be configured to process and diagnose quality-of-service problems that may be local to computing device 300.

Each of the above identified instructions and software applications may correspond to a set of instructions for performing one or more functions described above. These instructions may be implemented as separate software programs, procedures, or modules. The memory 350 may include additional instructions or fewer instructions. Furthermore, various functions of the computing device 300 may be implemented in hardware and/or in software, including in one or more signal processing and/or application specific integrated circuits.

The computing device 300 of FIG. 3 or the computing devices 101, 102, 103, 104, and 105 of FIG. 1 may execute various applications stored in memory 350. For the sake of the present disclosure, the memory 350 of the computing device 300 may store a conferencing application of a conferencing platform which, when executed by the processor 202, instructs the computing device to communicate with the conference management server 110 or other computing devices 101, 102, 103, 104, and 105 via the network 120 of FIG. 1. In an embodiment, the conferencing application may be a browser-based application being part of the conferencing platform. In another embodiment, the conferencing application may be an application that uses Web Real-Time Communication (WebRTC).

### Procedural Overview

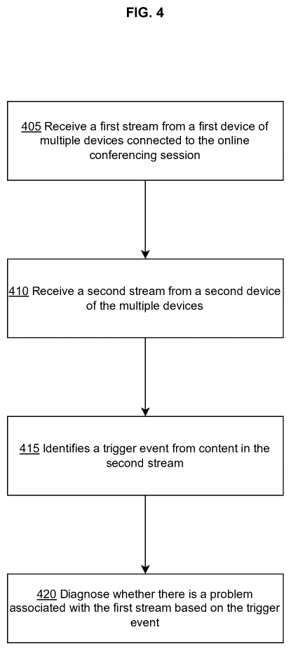

Refencing FIG. 4, it describes a flowchart for diagnosing whether there is a quality-of-service problem associated with a conferencing session based on an identified triggering event, according to an embodiment. Process 400 may be performed by a single program or multiple programs. The steps of the process as shown in FIG. 4 may be implemented using processor-executable instructions that are stored in computer memory. For the purposes of providing a clear example, the steps of FIG. 4 are described as being performed by computer programs executing on either conference management server 110 or computing device 300. For the purposes of clarity, process 400 is described in terms of a single entity.

At step 405, process 400 receives a first stream from a first computing device of multiple computing devices connected to the online conferencing session. In an embodiment, the audio video stream processor 210 receives the first stream from the first computing device, which is connected to the online conferencing session hosted by the conference management server 110. The first stream may represent either an audio stream or a video stream from the first computing device. For example, referring to FIG. 1, the first computing device may represent computing device 101. The first stream may be an audio stream generated by computing device 101 or a video stream generated by computing device 101.

At step 410, process 400 receives a second stream for a second computing device of the multiple computing devices. In an embodiment, the audio video stream processor 210 receives the second stream from the second computing device, where the second computing device represents computing device 102. Steps 405 and 410 may occur in any order or simultaneously. In other embodiments, where there are multiple computing devices connected to the conference management server 110 for a particular conferencing session, the audio video stream processor 210 may concurrently receive audio and video streams from each of the connected computing devices 101-105.

At step 415, process 400 identifies a trigger event from the content in the second stream. In an embodiment, the trigger event processing service 212 processes the second stream and identifies a trigger event from the content in the second stream. For example, the trigger event processing service 212, monitors the incoming second stream from computing device 102 for any potential trigger event. Examples of trigger events from an audio stream may include specific words or phrases, such as “wait!”, “no sound”, “no video”, and “hello, we can't hear you”. Examples of video stream-based trigger events may include specific gestures, such as waving hands, raising a hand, cupping of one's ear to indicate not hearing sound, or any other physical gesture. In some embodiments, the trigger event processing service 212 may implement a machine learning model to monitor the incoming streams for any potential trigger events.

At step 420, upon identifying a trigger event, process 400 diagnoses whether there is a problem associated with the first stream based on the trigger event. In an example embodiment, the trigger event processing service 212, upon identifying the trigger event from the second stream, determines whether the trigger event is associated with a quality-of-service problem with the first stream from the first computing device 101. For example, the trigger event processing service 212 may use historical meeting data to help evaluate whether the trigger event is indicative of a quality-of-service problem. The historical meeting data may include captured interactions from prior meetings, including historical interactions from participants specific to the current meeting. Additionally, the historical meeting data may be participant specific, department or group specific, or company specific. Using the historical interaction data, the trigger event processing service 212 determines whether the trigger event is indicative of a quality-of-service problem with the current meeting. In another embodiment, the trigger event processing service 212 may implement trained machine learning model 218 to determine whether the trigger event is associated with a quality-of-service problem with the first stream. In yet another embodiment, the trigger event processing service 212 may determine whether the trigger event is associated with a quality-of-service problem based on whether the trigger event processing service 212 identified multiple trigger events. For example, if the trigger event processing service 212 identifies a trigger event from computing device 101's stream and a second trigger event from computing device 102's stream and both trigger events are indicative of an audio stream issue, then the trigger event processing service 212 may determine that there is a quality-of-service challenge with audio streams based on the multiple trigger events.

In an embodiment, upon determining that the trigger event is indicative of a quality-of-service problem, the trigger event processing service 212 identifies the source of the quality-of-service deficiency. For example, computing device 101 may be presenting and sending audio and video streams to the conference server 101 and computing device 102 may be receiving the audio and video streams from computing device 101, via the conference server 101. If the participant using computing device 102 causes a trigger event that is determined to be indicative of a quality-of service problem, the trigger event processing service 212 may attempt to diagnose the source of the quality-of service defect. For instance, the trigger event processing service 212 may analyze the audio and/or video streams produced by the presenting computing device, computing device 101, and the audio and/or video streams received by the computing device that generated the trigger event, computing device 102. By analyzing streams from the presenting computing device, computing device 101, the trigger event processing service 212 may determine whether the source of the quality-of-service problem is the presenting computing device. Additionally, the trigger event processing service 212 may analyze streams received by the computing device that generated the trigger event, computing device 102, to determine whether the source of the quality-of-service problem is local to the computing device that reported the problem. Once the source of the quality-of-service problem has been identified, the trigger event processing service 212. In some embodiments, particularly when the quality-of-service problem is severely hindering one or more participants from meaningful participation, the trigger event processing service 212 may pause the conference until the quality-of-service problem is resolved. In such embodiments, the trigger event processing service 212 may send a notification to the participants advising that the conference is being paused pending resolution of the quality-of-service issue.

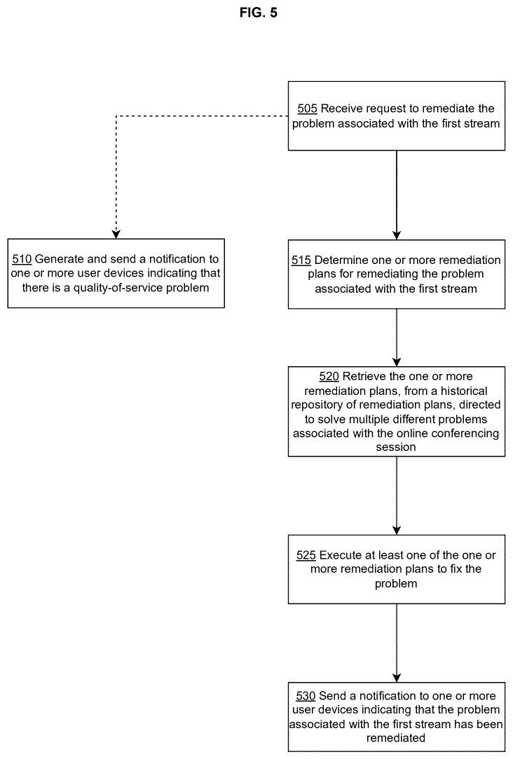

FIG. 5 depicts a flowchart for remediating an identified quality-of-service problem associated with a conferencing session based on an identified triggering event, according to an embodiment. Process 500 may be performed by a single program or multiple programs. The steps of the process as shown in FIG. 5 may be implemented using processor-executable instructions that are stored in computer memory. For the purposes of providing a clear example, the steps of FIG. 5 are described as being performed by computer programs executing on either conference management server 110 or computing device 300. For the purposes of clarity, process 500 is described in terms of a single entity.

At step 505, process 500 receives a request to remediate the problem associated with the first stream. In an embodiment, the event remediation service 216 receives a request, from the trigger event processing service 212 to remediate a problem that may be indicative of a quality-of-service problem. Referring to step 420 in FIG. 4, the trigger event processing service 212 diagnoses whether there is a problem associated with the first stream based on the identified trigger event. Upon determining that the problem is a quality-of-service problem, the trigger event processing service 212 may send a request to the event remediation service 216 to remediate the problem. In some examples, the request from the trigger event processing service 212 may include the trigger event, the identified quality-of-service problem, and a potential source of the quality-of-service problem.

At optional step 510, process 500 generates and sends a notification to one or more computing devices indicating that there is a quality-of-service problem. Upon receiving the request from the trigger event processing service 212 (step 505), the event remediation service 216 may, optionally, cause the notification generation service 214 to generate and send notifications to the computing devices connected to the online conferencing session. For example, if computing device 101 is presenting but is experiencing an audio stream transmission problem, the event remediation service 216, upon receiving the request to remediate the current problem, may cause the notification generation service 214 to generate and send notifications to the other computing devices 102-105 describing the current problem. In some examples, the notifications may contain content describing the quality-of-service problem and an estimated time to resolve the quality-of-service problem.

At step 515, process 500 determines one or more remediation plans for remediating the problem associated with the first stream. In an embodiment, the event remediation service 216 may determine one or more remediation plans for remediating the current quality-of-service problem based on the trigger event, the identified quality-of-service problem, and the potential source of the quality-of-service problem, provided by the trigger event processing service 212.

For example, if the quality-of-service problem identified is that the presenting computing device 101 is not providing any audio to other computing devices on the current online conferencing session. The event remediation service 216 may determine one or more remediation plans based on the presenting computing device 101 is not providing any audio to other computing devices. The one or more remediation plans may range from remediation plans to modify the current audio configuration preferences on computing device 101 to remediation plans to evaluate streams received by other computing devices 102-105. For example, remediation plans to modify the current audio configuration preferences on computing device 101 may include, but are not limited to, checking mute setting on computing device 101, checking microphone volume level, checking the audio stream generated by computing device 101, and any other diagnostic steps that may be performed to evaluate the presenting computing device 101. Examples of remediation plans to evaluate streams received by other computing devices 102-105 may include testing audio streams received by computing devices 102-105.

At step 520, process 500 retrieves the one or more remediation plans, from a historical repository of remediation plans, directed to solve multiple different problems associated with the online conferencing session. In an embodiment, the event remediation service 216 accesses the historical repository of remediation plans from database 111, where the historical repository of remediation plans contains remediation plans for fixing various quality-of-service problems from online conferencing sessions.

At step 525, process 500 executes at least one of the one or more remediation plans to fix the problem. In an embodiment, the event remediation service 216, upon retrieving the one or more remediation plans from database 111, may iteratively execute the one or more remediation plans to fix the problem. Prior to executing the one or more remediation plans, the event remediation service 216 may rank the one or more remediation plans based on the type of quality-of-service problem and the source of the problem. For example, if the quality-of service issue indicates that presenting computing device 101 is not providing any audio, then the event remediation service 216 may prioritize remediation plans that attempt to fix quality-of-service problems localized to presenting computing device 101 over other remediation plans that diagnose other computing devices 102-105 for potential audio issues. Remediation plans that focus on fixing issues local to presenting computing device 101 may be prioritized first, such as remediations plans directed to checking and fixing mute toggle issues, microphone configuration issues, audio volume issues, and any other configuration issue that may be affecting presenting computing device 101's ability to stream audio to the conference management server 110.

At step 530, process 500 sends a notification to one or more computing devices indicating that the problem associated with the first stream has been remediated. In an embodiment, upon remediating the quality-of-service problem, the notification generation service 214 generates and sends notifications to the computing devices in the online conferencing session. The content of the notification may include information indicating that the quality-of-service problem has been resolved.

### Machine Learning Model

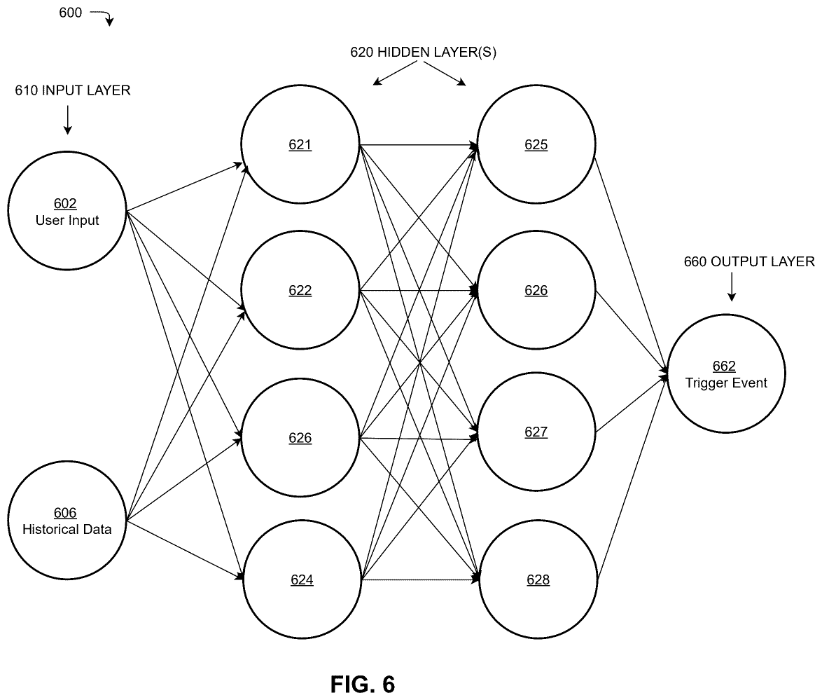

FIG. 6 represents an example machine learning (ML) model. Neural network 600 may utilize an input layer 610, one or more hidden layers 620, and an output layer 630 to train a machine learning algorithm or model to identify trigger events from streams. In some embodiments, where types of trigger events are identified, supervised learning is used such that known input data, a weighted matrix, and know output data are used to gradually adjust the model to accurately compute the already known output. In other embodiments, unstructured learning is used such that a model attempts to reconstruct known input data over time in order to learn.

Training of the neural network 600 using one or more training input matrices, a weight matrix and one or more known outputs may be initiated by one or more external computers associated with the collaboration environment. For example, the neural network 600 may be trained by one or more training computers and once trained, used in association with the conference management server 110 and/or user devices 102, 104, 106, or 108 to identify trigger events from streams. In an embodiment, a computing device may run known input data through a deep neural network 600 in an attempt to compute a particular known output. For example, a server computing device uses a first training input matrix and a default weight matrix to compute an output. If the output of the deep neural network does not match the corresponding known output of the first training input matrix, the server adjusts the weight matrix, such as by using stochastic gradient descent, to slowly adjust the weight matrix over time. The server then re-computes another output from the deep neural network with the input training matrix and the adjusted weight matrix. This process continues until the computer output matches the corresponding known output. The server then repeats this process for each training input dataset until a fully trained model is generated.

In the example of FIG. 6, the input layer 610 includes a plurality of training datasets that are stored as a plurality of training input matrices in an associated database, such as database 111. The training input data includes, for example, user input 602 and historical data 606. While the example of FIG. 6 uses a single neural network for both user input 602 and historical data 606, in some embodiments, one neural network 600 would be used to train a model for detecting trigger events solely based on the user input, while another neural network 600 would be used to train a multimodal model for detecting trigger events based on historical data. Any number of neural networks may be used to train the model.

In the embodiment of FIG. 6, hidden layers 620 represent various computational nodes 621, 622, 623, 624, 625, 626, 627, and 628. The lines between each node 621, 622, 623, 624, 625, 626, 627, and 628 represent weighted relationships based on the weight matrix. As discussed above, the weight of each line is adjusted over time as the model is trained. While the embodiment of FIG. 6 features two hidden layers 620, the number of hidden layers is not intended to be limiting. For example, one hidden layer, three hidden layers, ten hidden layers, or any other number of hidden layers may be used for a standard or deep neural network. The example of FIG. 6 also features an output layer 630 with the user intent 632 as the known output. The user intent 632 might be represented as a number indicating the percentage of the probability of the intent of the user to initiate a communication with another user. As discussed above, in this structured model, the user intent 632 is used as a target output for continuously adjusting the weighted relationships of the model. When the model successfully outputs user intent 632, then the model has been trained and may be used to process live or field data.

What is claimed is:

1. A computer-implemented method, comprising:
during an online conferencing session with multiple participants, receiving, by a conference management system, a first stream from a first computing device of multiple computing devices connected to the online conferencing session;
receiving, by the conference management system, a second stream of a content from a second computing device of the multiple computing devices;
identifying a trigger event from the content of the second stream;
diagnosing, by the conference management system, whether there is a problem associated with the first stream based on the trigger event.

2. The computer-implemented method of claim 1, further comprising sending an alert notification to the first computing device to alert the first participant of the problem.

3. The computer-implemented method of claim 2, further comprising, prior to sending the alert notification to the first computing device, including a diagnosis of the problem into the alert notification.

4. The computer-implemented method of claim 1, wherein diagnosing whether there is the problem associated with the first stream based on the trigger event, comprises:
determining whether the trigger event is indicative of the problem, wherein the problem is a quality-of-service problem; and
upon determining that the trigger event is indicative of the problem, identifying one or more potential sources of the problem.

5. The computer-implemented method of claim 1, wherein the second stream is a video stream and the trigger event represents one or more gestures indicating an issue hearing or viewing the first stream.

6. The computer-implemented method of claim 1, wherein the second stream is an audio stream and the trigger event represents speech from the audio stream indicating an issue hearing or viewing the first stream.

7. The computer-implemented method of claim 1, further comprising:
receiving, by the conference management system, a third stream from a third computing device of the multiple computing devices;
wherein the third stream contains content affirming the problem diagnosed from the trigger event and the first stream.

8. The computer-implemented method of claim 1, further comprising remediating, by the conference management system, the problem.

9. The computer-implemented method of claim 8, wherein remediating the problem further comprises:
using a machine learning model to determine one or more remediation plans to fix the problem using the second stream and the trigger event as input to the machine learning model; and
providing as output, from the machine learning model, the one or more remediation plans to resolve the problem.

10. The computer-implemented method of claim 8, wherein remediating the problem comprises:
determining one or more remediation plans for remediating the problem associated with the first stream;
retrieving the one or more remediation plans from a historical repository of remediation plans directed to solve multiple different problems associated with the online conferencing session;
executing at least one of the one or more remediation plans to fix the problem;
sending a notification to at least one computing device of the multiple computing devices connected to the online conferencing session indicating that the problem associated with the first stream has been remediated.

11. A system, comprising:
a processor; and
a memory storing instructions that, when executed by the processor, cause:
during an online conferencing session with multiple participants, receiving, by a conference management system, a first stream from a first computing device of multiple computing devices connected to the online conferencing session;
receiving, by the conference management system, a second stream of a content from a second computing device of the multiple computing devices;
identifying a trigger event from the content of the second stream;
diagnosing, by the conference management system, whether there is a problem associated with the first stream based on the trigger event.

12. The system of claim 11, wherein the memory further stores instructions comprising sending an alert notification to the first computing device to alert the first participant of the problem.

13. The system of claim 12, wherein the memory further stores instructions comprising prior to sending the alert notification to the first computing device, inserting a diagnosis of the problem into the alert notification.

14. The system of claim 11, wherein diagnosing whether there is the problem associated with the first stream based on the trigger event, comprises:
determining whether the trigger event is indicative of the problem, wherein the problem is a quality-of-service problem; and
upon determining that the trigger event is indicative of the problem, identifying one or more potential sources of the problem.

15. The system of claim 11, wherein the memory further stores instructions comprising remediating the problem by:
determining one or more remediation plans for remediating the problem associated with the first stream;
retrieving the one or more remediation plans from a historical repository of remediation plans directed to solve multiple different problems associated with the online conferencing session;
executing at least one of the one or more remediation plans to fix the problem;
sending a notification to at least one computing device of the multiple computing devices connected to the online conferencing session indicating that the problem associated with the first stream has been remediated.

16. A non-transitory, computer-readable medium, storing a set of instructions that, when executed by the processor, cause:
during an online conferencing session with multiple participants, receiving, by a conference management system, a first stream from a first computing device of multiple computing devices connected to the online conferencing session;
receiving, by the conference management system, a second stream of a content from a second computing device of the multiple computing devices;
identifying a trigger event from the content of the second stream;
diagnosing, by the conference management system, whether there is a problem associated with the first stream based on the trigger event.

17. The non-transitory, computer-readable medium of claim 16, wherein the memory further stores instructions comprising sending an alert notification to the first computing device to alert the first participant of the problem.

18. The non-transitory, computer-readable medium of claim 17, wherein the memory further stores instructions comprising prior to sending the alert notification to the first computing device, inserting a diagnosis of the problem into the alert notification.

19. The non-transitory, computer-readable medium of claim 16, wherein diagnosing whether there is the problem associated with the first stream based on the trigger event, comprises:
determining whether the trigger event is indicative of the problem, wherein the problem is a quality-of-service problem; and
upon determining that the trigger event is indicative of the problem, identifying one or more potential sources of the problem.

20. The non-transitory, computer-readable medium of claim 16, wherein the memory further stores instructions comprising remediating the problem by:
determining one or more remediation plans for remediating the problem associated with the first stream;
retrieving the one or more remediation plans from a historical repository of remediation plans directed to solve multiple different problems associated with the online conferencing session;
executing at least one of the one or more remediation plans to fix the problem;
sending a notification to at least one computing device of the multiple computing devices connected to the online conferencing session indicating that the problem associated with the first stream has been remediated.
